(19) United States
(12) Patent Application Publication
(10) Pub. No.: US 2011/0194808 A1
(43) Pub. Date: Aug. 11, 2011

(54) OPTICAL CONNECTOR AND OPTICAL LINK APPARATUS INCLUDING THE SAME

(75) Inventors: Do Won KIM, Daejeon (KR); Gyungock KIM, Seoul (KR); Duk Jun KIM, Daejeon (KR)

(73) Assignee: ELECTRONICS AND TELECOMMUNICATIONS RESEARCH INSTITUTE, Daejeon (KR)

(21) Appl. No.: 12/887,015

(22) Filed: Sep. 21, 2010

(30) Foreign Application Priority Data
Feb. 5, 2010 (KR) 10-2010-0010973

(51) Int. Cl. G02B 6/12; G02B 6/36

(52) U.S. Cl. 385/14; 385/88

(57) ABSTRACT

Provided is an optical connector that can improve coupling efficiency and coupling reliability. The optical connector includes an optical fiber guiding pad configured to guide an optical fiber connected to an optical waveguide that is disposed on an optoelectronic device IC, or includes a ferrule guiding pad and a ferrule guiding bar that guide a ferrule coupled to the optoelectronic device IC.

### CROSS-REFERENCE TO RELATED APPLICATIONS

This U.S. non-provisional patent application claims priority under 35 U.S.C. §119 of Korean Patent Application No. 10-2010-0010973, filed on Feb. 5, 2010, the entire contents of which are hereby incorporated by reference.

### BACKGROUND OF THE INVENTION

The present inventive concept disclosed herein relates to an optical connector and an optical link apparatus including the optical connector, and more particularly, to an optical connector connecting an optical waveguide with an optical fiber, and an optical link apparatus including the optical connector.

Data transmission technology using light is very promising in transmitting large capacity data at high speed, which is required in the information and telecommunication (IT)-oriented society. According to this advantage, long-haul optical communication technology has been developed and commercialized from early on, and recently, active research is being carried out on short-haul optical interconnection. The Korean Electronics and Telecommunications Research Institute (ETRI) has developed an inter-board optical interconnection system to demonstrate optical interconnection at 10 Gbps, and the Korea Advanced Institute of Science and Technology (KAIST) has developed a printed circuit board (PCB) with an embedded optical waveguide to successfully achieve optical interconnection at 10 Gbps. These optical interconnection technologies show great potential to be applied to HP TVs, super computers, server computers, personnel computers, and mobile devices. The optical interconnection technology can be applied principally by packaging optoelectronic devices such as a light emitting device, a light receiving device, an optical waveguide, an optical modulator, a multiplexer (MUX), and a de-multiplexer (DeMUX). In this case, optical signals are transmitted and received through an optical waveguide. Recently, active research has been being carried out on silicon photonics technology for integrating passive and active optical devices in a single chip, which will be applied to personal computers within 10 years.

In the data transmission technology using light, various methods for optical connectors configured to connect a light source and transmit and receive an optical signal have been introduced. Various types of optical connector devices and technologies for long-haul optical communications has been developed, and optical connectors having high coupling efficiency has been applied to various fields. Connection of a light source in short-haul optical connection is also an important technology. Flip chip bonding, optical alignment through die bonding, and guide pin-guide pin hole connection using a ferrule are representative technologies. Also in silicon photonics technology, which is recently researched with much interest all over the world, connection and integration of a light source is a key technology. Intel, UC Santa Babara, IBM and Luxtera of the US have been also researching connection of a light source to a silicon photonics chip, and presented their research results. Intel and UC Santa Babara have successfully developed an avanescent laser diode as a joint research project. Luxtera have developed an optical signal transmission technology using connection of an angled-fiber to a grating coupler, and announced successful light source connection using a TO Can laser light source and a lens.

Despite these various types of research and results, development of an optical connector for inputting/outputting optical signals to/from an optoelectronic device chip can be regarded still as a major topic. It is necessary to achieve high optical coupling efficiency, and simultaneously, to achieve optical connection using a relatively easy method in passive way. It is also necessary to maintain the reliability of optical connection states without a great variation after a long-term use thereof.

### SUMMARY OF THE INVENTION

The present inventive concept provides an optical connector that can improve coupling efficiency, and an optical link apparatus including the optical connector.

The present inventive concept also provides an optical connector that can improve optical coupling reliability, and an optical link apparatus including the optical connector.

Embodiments of the present inventive concept may provide optical connectors including: an optoelectronic device integrated circuit (IC); at least one optical waveguide disposed on the optoelectronic device IC; and a guide part disposed on the optoelectronic device IC at both sides of the optical waveguide and guiding an optical fiber, connected to the optical waveguide.

In some embodiments, the guide part may include a plurality of guiding pads that are disposed at both the sides of the optical waveguide and protrude to an upper side of the optoelectronic device IC.

In other embodiments, the guiding pads may be symmetrically disposed at both sides of the optical waveguide.

In still other embodiments, the guiding pad may be thicker than the optical fiber.

In even other embodiments, the guide part may include a plurality of ferrule guiding pads disposed on the optoelectronic device IC at both sides of a ferrule aligning the optical fiber, and guiding the ferrule to the optoelectronic device IC.

In yet other embodiments, the ferrule may have an end coupled with the optoelectronic device IC, and the end may have an inclination surface inclined from an upper surface of the optoelectronic device IC.

In further embodiments, the ferrule may include a hole extending in a direction to face the optoelectronic device IC, and a guide pin inserted in the hole.

In still further embodiments, the optical connectors may further include an optical coupler disposed between the optical waveguide and the optical fiber.

In even further embodiments, the optical coupler may include a grating coupler.

In other embodiments of the present inventive concept, optical link apparatuses include: an optical fiber; a ferrule aligning the optical fiber; and an optical connector including an optoelectronic device integrated circuit (IC) coupled to the ferrule, at least one optical waveguide disposed on the optoelectronic device IC, an optical coupler in the optical waveguide, and a guide part disposed on the optoelectronic device IC at both sides of the optical waveguide and guiding an optical fiber, connected to the optical waveguide, to the optical waveguide.

In some embodiments, the guide part may include a plurality of guiding pads that are disposed at both the sides of the optical waveguide and protrude to an upper side of the optoelectronic device IC.

In other embodiments, the optical connector may include a plurality of ferrule guiding pads disposed on the optoelectronic device IC at both sides of the ferrule aligning the optical fiber, and guiding the ferrule to the optoelectronic device IC.

### BRIEF DESCRIPTION OF THE FIGURES

The accompanying figures are included to provide a further understanding of the present inventive concept, and are incorporated in and constitute a part of this specification. The drawings illustrate exemplary embodiments of the present inventive concept and, together with the description, serve to explain principles of the present inventive concept. In the figures:

FIG. 1 is a perspective view illustrating an optical connector according to an embodiment of the present inventive concept;

FIG. 2 is a perspective view illustrating a ferrule and optical fibers connected to the optical connector of FIG. 1;

FIG. 3 is a cross-sectional view taken along line I-I′ of FIG. 2;

FIGS. 4 and 5 are perspective views illustrating an optical connector according to another embodiment of the present inventive concept;

FIG. 6 is a cross-sectional view taken along line II-IF of FIG. 5;

FIG. 7 is a cross-sectional view illustrating a ferrule and guide pins of FIG. 5;

FIGS. 8 and 9 are cross-sectional views illustrating types of optical fibers inserted in through holes of ferrules, according to an embodiment of the present inventive concept; and

FIG. 10 is a cross-sectional view illustrating a ferrule and an optical fiber according to an embodiment of the present inventive concept.

### DETAILED DESCRIPTION OF PREFERRED EMBODIMENTS

Preferred embodiments of the present inventive concept will be described below in more detail with reference to the accompanying drawings. The present inventive concept may, however, be embodied in different forms and should not be constructed as limited to the embodiments set forth herein. Rather, these embodiments are provided so that this disclosure will be thorough and complete, and will fully convey the scope of the present inventive concept to those skilled in the art. Like reference numerals refer to like elements throughout the specification.

In the following description, the technical terms are used only for explaining a specific exemplary embodiment while not limiting the present inventive concept. The meaning of ‘comprises’ and/or ‘comprising’ specifies a property, a region, a fixed number, a step, a process, an element and/or a component but does not exclude other properties, regions, fixed numbers, steps, processes, elements and/or components. Since preferred embodiments are provided below, the order of the reference numerals given in the description is not limited thereto. In the specification, it will be understood that when a layer is referred to as being ‘on’ another layer or integrated circuit (IC), it can be directly on the other layer or IC, or intervening layers may also be present.

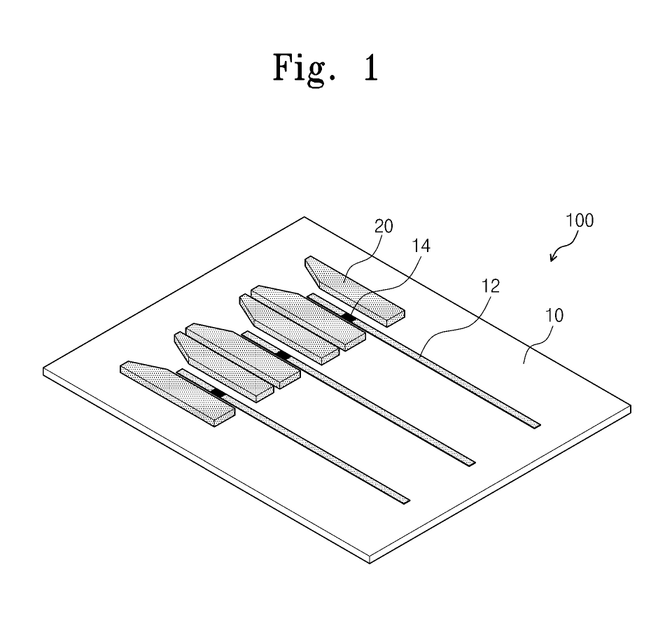

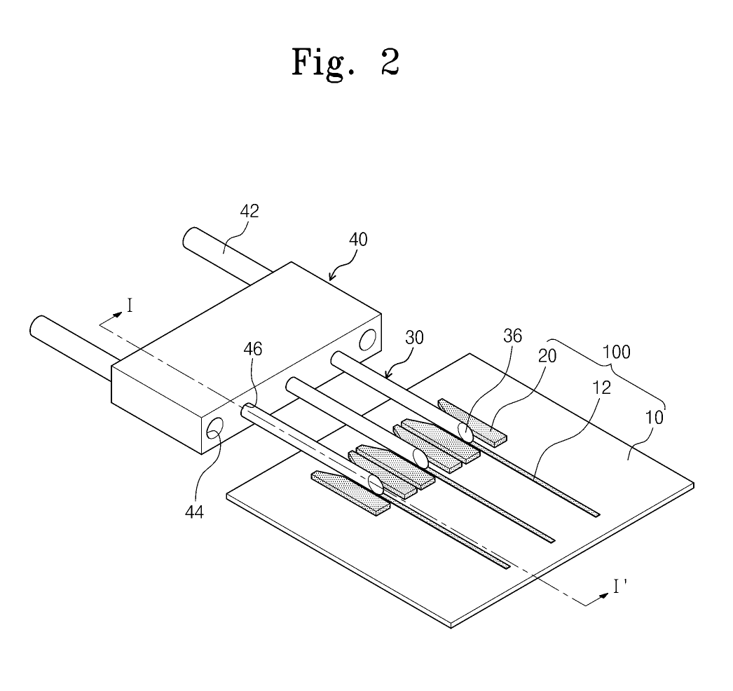

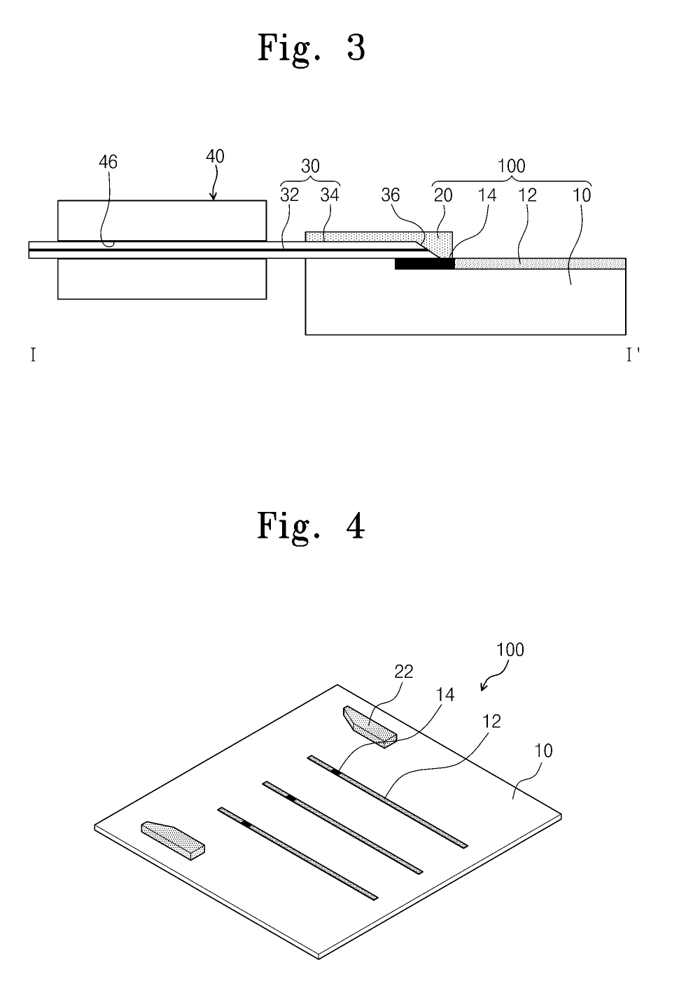

FIG. 1 is a perspective view illustrating an optical connector according to an embodiment of the present inventive concept. FIG. 2 is a perspective view illustrating a ferrule and optical fibers connected to the optical connector of FIG. 1. FIG. 3 is a cross-sectional view taken along line I-I′ of FIG. 2.

Referring to FIG. 1 through 3, an optical connector 100 according to the embodiment of the present inventive concept may include a plurality of guiding pads 20 that guide optical fibers 30 at both sides of each of optical waveguides 12 when the optical fibers 30 are connected to the optical waveguides 12 exposed to the upper side of an optoelectronic device IC 10.

The optical fibers 30 may be inserted between the guiding pads 20. The optical fibers 30 may be coupled to optical couplers 14 that are formed in the optical waveguides 12 on the optoelectronic device IC 10. The guiding pads 20 may be spaced the diameter of the optical fiber 30 from each other at both the sides of each of the optical waveguides 12 formed on the optoelectronic device IC 10. The guiding pads 20 may be a greater thickness than that of the optical fiber 30 on the optoelectronic device IC 10.

Thus, the optical connector 100 can use the guiding pads 20 guiding the optical fibers 30 to improve efficiency in aligning the optical fibers 30. In addition, optical coupling efficiency between the optical couplers 14 and the optical fibers 30 inserted between the guiding pads 20 can be improved.

The optical couplers 14 may transmit input/output optical signals between the optical fibers 30 and the optical waveguides 12. The optical couplers 14 may be disposed at the inside or upper side of the optoelectronic device IC 10. For example, the optical couplers 14 may include a grating coupler. The grating coupler may include a plurality of grooves, having one of a line shape, a mesh shape, and a concentric circle shape, formed in the optical waveguides 12 contacting the optical fibers 30.

The optical waveguides 12 may transmit optical signals input/output to/from the optical fibers 30 through the optical couplers 14 to the optoelectronic device IC 10. The optical waveguides 12 may be disposed at the inside or upper side of the optoelectronic device IC 10. For example, the optical waveguides 12 may be formed of single crystalline silicon or poly-silicon. The optical waveguide 12 may be connected to an optoelectronic device (not shown) formed in the optoelectronic device IC 10. Although not shown, the optoelectronic device IC 10 may include at least one of a light emitting device, a light receiving device, an optical amplifier, an optical modulator, a multiplexer (MUX), and a de-multiplexer (DeMUX).

The optical fibers 30 may be ground to be inclined with a predetermined angle at portions connected to the optical waveguides 12. A first inclination surface 36 may internally reflect light, which is input/output through a core 32, toward the optical waveguides 12. For example, the optical fiber 30 may be ground such that the first inclination surface 36 has an angle ranging from about 20° to about 60° from the upper surface of the optoelectronic device IC 10. In detail, the first inclination surface 36 may have an angle of about 45°.

The optical fibers 30 may be aligned by a ferrule 40. The ferrule 40 may fix a plurality of the optical fibers 30 connected to the optical couplers 14 of the optoelectronic device IC 10. The ferrule 40 may be spaced a predetermined distance or greater from the optoelectronic device IC 10. The ferrule 40 may include stainless steel, polymer, or ceramic. The ferrule 40 may have one or more through holes 46 which pass through the optical fibers 30. The ferrule 40 may include guide pins 42 formed outside the through holes 46. The guide pins 42 may be inserted in guide holes, 44 that are formed in the ferrule 40, in a direction to face the optoelectronic device IC 10. When the ferrule 40 is connected to another ferrule or the optical connector 100, the guide pins 42 may guide the ferrule 40. The lower part of the ferrule 40 may be partially removed to expose cladding portions of the optical fibers 30 to the outside when the optical fibers 30 are inserted.

The guiding pads 20 may function as an optical fiber guide part configured to guide the optical fibers 30 connected to the optical waveguides 12 on the optoelectronic device IC 10. The guiding pads 20 may guide the optical fibers 30 to be parallel to the optical waveguides 12. The guiding pads 20 disposed at both the sides of the optical waveguide 12 may protrude to the upper side of the optoelectronic device IC 10. The guiding pads 20 may be spaced the same distance as that of the optical fibers 30 from each other.

The guiding pads 20 may be disposed on the optoelectronic device IC 10 at both sides of the optical coupler 14 and the optical waveguide 12. The guiding pads 20 may guide the optical fibers 30 in a lateral direction (in a line width direction of the optical fibers 30). Although the guiding pads 20 may be illustrated not to guide the optical fibers 30 in a longitudinal direction (in a length direction of the optical fibers 30) in FIGS. 1 and 3, the guiding pads 20 may guide the optical fibers 30 in a longitudinal direction. The guiding pads 20 may be formed increasing in a distance from the optical waveguides 12 to in a direction of a portion connected to the optical fibers 30. Accordingly, the optical fibers 30 extending out of the optoelectronic device IC 10 are allowed to laterally move in the guiding pads 20. For example, the guiding pads 20 may include poly-silicon and an organic compound patterned through a photolithography process.

The optical connector 100 according to the embodiment of the present inventive concept use may the guiding pads 20 formed at both the sides of the optical waveguides 12 on the optoelectronic device IC 10 to improve coupling efficiency between the optical waveguides 12 and the optical fibers 30.

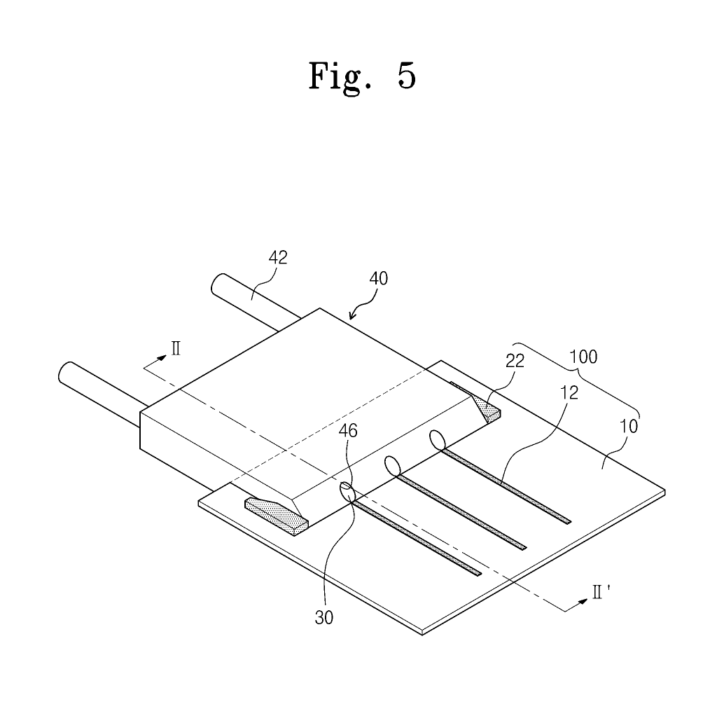

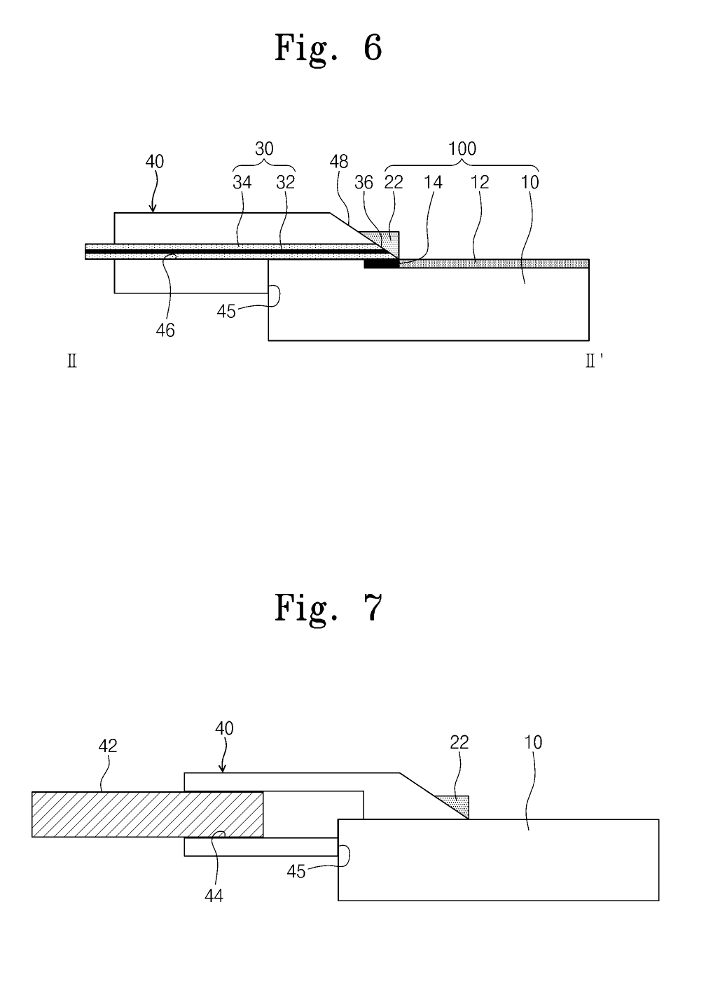

FIGS. 4 and 5 are perspective views illustrating a connection structure of an optical connector according to another embodiment of the present inventive concept. FIG. 6 is a cross-sectional view taken along line II-IF of FIG. 5. FIG. 7 is a cross-sectional view illustrating a ferrule and guide pins of FIG. 5.

Referring to FIG. 4 through 7, an optical connector 100 according to the embodiment of the present inventive concept may include a plurality of ferrule guiding pads 22 on an optoelectronic device IC 10 provided with optical waveguides 12. The ferrule guiding pads 22 may guide a ferrule 40 that aligns optical fibers 30 when the optical fibers 30 are connected to the optical waveguides 12.

The ferrule 40 may be inserted between the ferrule guiding pads 22. The ferrule 40 may include a stepped part 45 that faces a side surface of the optoelectronic device IC 10. The lower portion of a predetermined part of the ferrule 40 may be removed to expose cladding parts of the optical fibers 30 to the outside when the optical fibers 30 are inserted in the ferrule 40. The ferrule guiding pads 22 may be spaced apart from each other at both the outermost sides of the optical waveguides 12 that are formed on the optoelectronic device IC 10, so that the ferrule 40 can be inserted between the ferrule guiding pads 22. A plurality of guide pins 42 may be inserted in guide holes 44 formed in the ferrule 40.

Thus, the optical connector 100 according to the embodiment of the present inventive concept may use the ferrule guiding pads 22 that guides the ferrule 40 configured to align the optical fibers 30, and the guide bars 42 that align the ferrule 40 with the optoelectronic device IC 10 to improve efficiency in aligning the optical fibers 30. In addition, reliability in coupling the optical fibers 30 aligned in the ferrule 40 to the optical waveguides 12 on the optoelectronic device IC 10 can be improved.

Optical couplers 14 may transmit input/output optical signals between the optical fibers 30 and the optical waveguides 12. The optical couplers 14 may be disposed at the inside or upper side of the optoelectronic device IC 10. For example, the optical couplers 14 may include a grating coupler. The grating coupler may include a plurality of grooves having one of a line shape, a mesh shape, and a concentric circle shape formed in the optical waveguides 12 contacting the optical fibers 30.

The optical waveguides 12 may be flat in the same plane as that of the optoelectronic device IC 10. For example, the optical waveguides 12 may be formed of single crystalline silicon or poly-silicon. The optical waveguide 12 may be connected to an optoelectronic device formed in the optoelectronic device IC 10. Although not shown, the optoelectronic device may include at least one of a light emitting device, a light receiving device, an optical amplifier, an optical modulator, a multiplexer (MUX), and a de-multiplexer (DeMUX). The optoelectronic device IC 10 may be formed of a silicon oxide or glass, which has lower refractivity than that of the optical waveguides 12.

The optical fiber 30 may include a core 32 transmitting light and a cladding 34 surrounding the core 32. The core 32 may have higher refractivity than that of the cladding 34. The optical fibers 30 may be ground to be inclined with a predetermined angle at portions connected to the optical waveguides 12. A first inclination surface 36 may internally reflect light, which is input/output through the core 32, toward the optical waveguides 12. For example, the first inclination surface 36 of the optical fibers 30 may have an angle ranging from about 20° to about 60°. In detail, the first inclination surface 36 may have an angle of about 45°. The optical fibers 30 may be aligned by the ferrule 40.

The ferrule 40 may fix the optical fibers 30 connected to the optical couplers 14 of the optoelectronic device IC 10. The ferrule 40 may overlap and be coupled with the optoelectronic device IC 10. The ferrule 40 may be inserted between the ferrule guiding pads 22. The stepped part 45 of the ferrule 40 may contact with a side wall of the optoelectronic device IC 10. The ferrule 40 may fix the optical fibers 30 to be spaced the same distance as that of the optical waveguides 12, formed on the optoelectronic device IC 10, from each other. The ferrule 40 may include stainless steel, polymer, or ceramic. The ferrule 40 may have the guide holes 44 that are formed in a direction to face the optoelectronic device IC 10. The guide pins 42 may be inserted in the guide holes 44. When the ferrule 40 is optically connected to another ferrule, the guide pins 42 may guide the ferrule 40. The ferrule 40 may have one or more through holes 46 which pass through the optical fibers 30. The through holes 46 may expose the claddings 34 of the optical fibers 30 in a portion that overlaps the optoelectronic device IC 10. The ferrule 40 may include a second inclination surface 48 having an angle that is equal or similar to that of the first inclination surface 36 of the optical fiber 30. Thus, the ferrule 40 may be ground together with the optical fibers 30. An end of the ferrule 40 may be inclined such that the second inclination surface 48 has an angle ranging from about 20° to about 60° from the upper surface of the optoelectronic device IC 10. The first and second inclination surfaces 36 and 38 may change optical paths of the optical fibers 30.

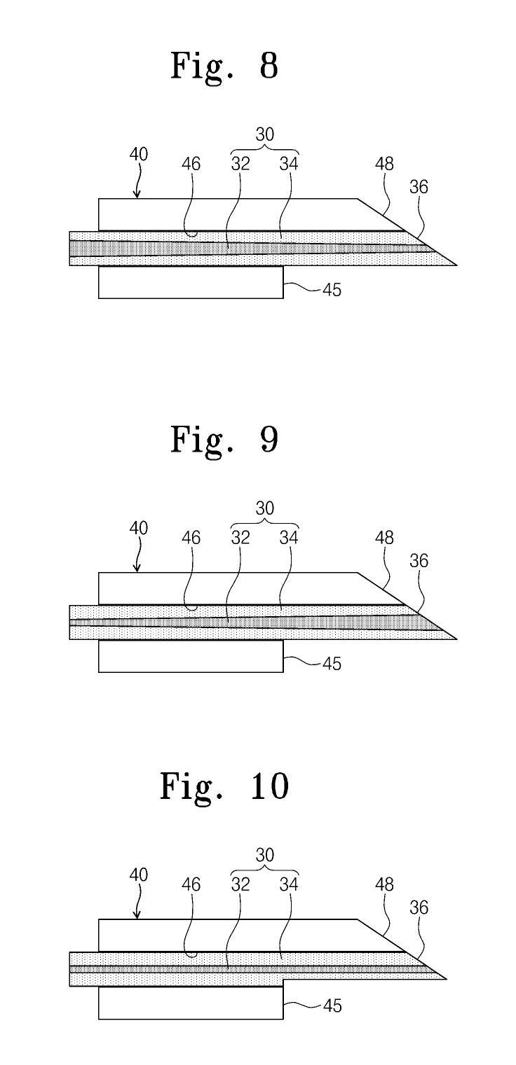

FIGS. 8 and 9 are cross-sectional views illustrating the optical fiber 30 inserted in the through hole 46 of the ferrule 40. As the diameter of the core 32 increases or decreases in any one direction in the ferrule 40, optical coupling efficiency of the optical fiber 30 may increase.

FIG. 10 is a cross-sectional view illustrating the ferrule 40 and the optical fiber 30. The cladding 34 of the optical fiber 30 may be partially ground in a region in which the ferrule 40 and the optical fiber 30 are coupled to the optoelectronic device IC 10. Referring to FIGS. 5 and 10, when the cladding 34 has a thickness of about 50 μm or greater, optical loss of the optical fiber 30 may be increased by the emanation and scattering of light. The cladding 34 of the optical fiber 30 may be partially removed in a portion that is connected to the optical waveguides 12 formed on the optoelectronic device IC 10. The stepped part 45 of the ferrule 40 may be ground by a removed amount of the cladding 34 of the optical fiber 30. Thus, the ferrule 40 and the optical fiber 30 may bring the core 32 closer to the optical waveguide 12.

The ferrule guiding pads 22 may function as a guide part that guides the ferrule 40 coupled to the optoelectronic device IC 10. The ferrule guiding pads 22 may guide the ferrule 40 to be parallel to the optical waveguides 12. The ferrule guiding pads 22 disposed at both the sides of the ferrule 40 may protrude to the upper side of the optoelectronic device IC 10. The ferrule guiding pads 22 may guide the ferrule 40 in a lateral direction (in a line width direction of the optical fibers 30). Although the ferrule guiding pads 22 may be illustrated not to guide the ferrule 40 in a longitudinal direction (a length direction of the optical fibers 30) in FIGS. 4 through 6, the ferrule guiding pads 22 may guide the ferrule 40 in a longitudinal direction. The ferrule guiding pads 22 may be formed increasing in a distance from the optical waveguides 12 toward a portion connected to the optical fibers 30. Thus, the ferrule guiding pads 22 may guide the ferrule 40 coupled to the optoelectronic device IC 10. For example, the ferrule guiding pads 22 may include poly-silicon and an organic compound patterned through a photolithography process.

Thus, the optical connector 100 according to the embodiments of the present inventive concept may use the ferrule guiding pads 22 that guides the optical fibers 30 or the ferrule 40 configured to align the optical fibers 30, to improve coupling efficiency and coupling reliability.

As described above, according to the embodiments of the present inventive concept, the guiding pads that guide the optical fibers to the optical waveguides can be used to improve the coupling efficiency.

Since the optical fibers are inserted between the guiding pads to easily couple the optical waveguide with the optical fibers, the optical coupling reliability can be improved.

The above-disclosed subject matter is to be considered illustrative, and not restrictive, and the appended claims are intended to cover all such modifications, enhancements, and other embodiments, which fall within the true spirit and scope of the present inventive concept. Thus, to the maximum extent allowed by law, the scope of the present inventive concept is to be determined by the broadest permissible interpretation of the following claims and their equivalents, and shall not be restricted or limited by the foregoing detailed description.

What is claimed is:

1. An optical connector comprising:
an optoelectronic device integrated circuit (IC);
at least one optical waveguide formed on the optoelectronic device IC; and
a guide part formed on the optoelectronic device IC at both sides of the optical waveguide and guiding an optical fiber, connected to the optical waveguide, to the optical waveguide.

2. The optical connector of claim 1, wherein the guide part comprises a plurality of guiding pads that are disposed at both the sides of the optical waveguide and protrude to an upper side of the optoelectronic device IC.

3. The optical connector of claim 2, wherein the guiding pads are symmetrically disposed at both the sides of the optical waveguide.

4. The optical connector of claim 2, wherein the guiding pad is thicker than the optical fiber.

5. The optical connector of claim 1, wherein the guide part comprises a plurality of ferrule guiding pads disposed on the optoelectronic device IC at both sides of a ferrule aligning the optical waveguide, and guiding the ferrule to the optoelectronic device IC.

6. The optical connector of claim 5, wherein the ferrule comprises a stepped part coupled to a side wall of the optoelectronic device IC.

7. The optical connector of claim 5, wherein the ferrule has an end coupled with the optoelectronic device IC, and the end has an inclination surface inclined from an upper surface of the optoelectronic device IC.

8. The optical connector of claim 5, wherein the ferrule comprises a hole extending in a direction to face the optoelectronic device IC, and a guide pin inserted in the hole.

9. The optical connector of claim 1, further comprising an optical coupler formed between the optical waveguide and the optical fiber.

10. The optical connector of claim 9, wherein the optical coupler comprises a grating coupler.

11. An optical link apparatus comprising:
an optical fiber;
a ferrule aligning the optical fiber; and
an optical connector including an optoelectronic device integrated circuit (IC) coupled to the ferrule, at least one optical waveguide disposed on the optoelectronic device IC, and a guide part disposed on the optoelectronic device IC at both sides of the optical waveguide and guiding an optical fiber, connected to the optical waveguide, to the optical waveguide.

12. The optical link apparatus of claim 11, wherein the guide part comprises a plurality of guiding pads that are disposed at both the sides of the optical waveguide and protrude to an upper side of the optoelectronic device IC.

13. The optical link apparatus of claim 10, wherein the optical connector comprises a plurality of ferrule guiding pads disposed on the optoelectronic device IC at both sides of the ferrule aligning the optical waveguide, and guiding the ferrule to the optoelectronic device IC.
